(19) United States
(12) Patent Application Publication
(10) Pub. No.: US 2011/0198268 A1
(43) Pub. Date: Aug. 18, 2011

(54) HYBRID ROTARY SCREEN SEPARATOR

(75) Inventor: David DeWaard, Lynden, WA (US)

(73) Assignee: DARITECH, INC., Lynden, WA (US)

(21) Appl. No.: 13/029,808

(22) Filed: Feb. 17, 2011

Related U.S. Application Data
(60) Provisional application No. 61/305,474, filed on Feb. 17, 2010.

(51) Int. Cl. B03B 5/56; B07B 1/22

(52) U.S. Cl. 209/270

(57) ABSTRACT

The present invention may be embodied as a rotary screen separator for processing feed material. A separator member defines a longitudinal axis, an input port, an output port, a fine perforation region, and a coarse perforation region. A collector structure defines a fine material output and a coarse material output. A support structure supports the separator member and the collector structure. A drive system rotates the separator member relative to the support structure. Operation of the drive system displaces feed material through the fine perforation region and the coarse perforation region. A first portion of the feed material flows through the separator member to the fine material output in the fine perforation region. A second portion of the feed material flows through the separator member to the coarse material output in the coarse perforation region. A third portion of the feed material flows through the output port.

### RELATED APPLICATIONS

This application claims priority benefit of U.S. Ser. No. 61/305,474, filed Feb. 17, 2010.

The contents of all related application(s) identified in this section are incorporated herein by reference.

### TECHNICAL FIELD

This disclosure relates to the field of rotary separators and, more particularly, to rotary separators that are used to separate effluent into different fractions depending upon the diameter of the solid components.

### BACKGROUND

Rotary screen separators are often used to process effluent such as waste from a dairy operation. Generally speaking, rotary screen separators separate a feed material into solid and liquid components by displacing the feed material along a first side of a screen such that solid material remains on the first side and liquid material passes through perforations in the screen to a second side thereof.

Conventionally, rotary screen separators employ a screen having a single predetermined screen size. When a conventional rotary screen is provided with a screen having a fine openings, very little solid material passes through the screen. However, a screen with fine openings also does not allow as much liquid material through the perforations as does a coarse screen. Conversely, a coarse screen allows an increased volume of liquid material to flow through the perforations, but a separator having a coarse screen may allow an undesirably high volume of the solids to escape with the increased volume of liquid material.

The need exists for an improved rotary screen separator that optimizes the removal of solids and water from a feed material.

### SUMMARY

The present invention may be embodied as a rotary screen separator for processing feed material comprising a separator member, a collector structure, a support structure, and a drive system. The separator member defines a longitudinal axis, an input port, an output port, a fine perforation region, and a coarse perforation region. The fine perforation region is arranged between the input port and the output port, and the coarse perforation region is arranged between the fine perforation region and the output port. The collector structure defines a fine material output and a coarse material output. The support structure supports the separator member and the collector structure. The drive system rotates the separator member relative to the support structure. Operation of the drive system displaces feed material from the input port to the output port through the fine perforation region and the coarse perforation region. A first portion of the feed material flows through the separator member to the fine material output in the fine perforation region. A second portion of the feed material flows through the separator member to the coarse material output in the coarse perforation region. A third portion of the feed material flows through the output port.

The present invention may also be embodied as a method of processing feed material to separate the feed material into separate portions comprising the following steps. A separator member defining a longitudinal axis, an input port, an output port, a fine perforation region, and a coarse perforation region is provided. The fine perforation region is arranged between the input port and the output port, and the coarse perforation region is arranged between the fine perforation region and the output port. A collector structure defining a fine material output and a coarse material output is supported relative to the separator member. The separator member is rotated relative to the support structure such that the feed material is displaced from the input port to the output port through the fine perforation region and the coarse perforation region. A first portion of the feed material that flows through the separator member in the fine perforation region is collected at the fine material output. A second portion of the feed material that flows through the separator member in the coarse perforation region is collected at the coarse material output. A third portion of the feed material is allowed to flow through the output port.

The present invention may also be embodied as a rotary screen separator for processing feed material comprising a perforated separator member, at least one vane operatively connected to the separator member, a collector structure, a support structure, and a drive system. The perforated separator member defining a longitudinal axis, an input port, an output port, a fine perforation region, and a coarse perforation region. The fine perforation region is arranged between the input port and the output port and the coarse perforation region is arranged between the fine perforation region and the output port. Perforations in the first perforation member are smaller than perforations in the second perforation member. The collector structure defines a fine material output and a coarse material output. A support structure supports the separator member and the collector structure at an angle with respect to horizontal. The drive system rotates the separator member relative to the support structure. Operation of the drive system causes the at least one vane to displace feed material from the input port to the output port through the fine perforation region and the coarse perforation region. The first portion of the feed material flows through the separator member to the fine material output in the fine perforation region. A second portion of the feed material flows through the separator member to the coarse material output in the coarse perforation region. A third portion of the feed material flows through the output port.

### BRIEF DESCRIPTION OF THE DRAWINGS

FIG. 1 is a perspective view from the output port end of a first example rotary screen separator of the invention;

FIG. 2 is a cutaway side view of the first example rotary screen separator;

FIG. 3 is a perspective view from the input end of the first example rotary screen separator;

FIG. 4 is a perspective view of the underside of the first example rotary screen separator from a first perspective;

FIG. 5 is a perspective hidden line view of the underside of the first example rotary screen separator from a second perspective;

FIG. 6 is a perspective detail view of the input end of a rotary screen separator in one form.

FIG. 7 is a perspective top view of the first example rotary screen separator;

FIG. 8 is a partial hidden line view of the input end of the first example rotary screen separator;

FIG. 9 is a perspective view of the underside of the first example rotary screen separator;

FIG. 10 is a block diagram of a first example waste processing system using a rotary screen separator of the present invention;

FIG. 11 is a block diagram of the rotary screen separator of the firs example waste processing system.

### DETAILED DESCRIPTION

A rotary screen separator is disclosed herein which may generally comprise a frame and a rotating perforated screen supported by the frame. In one form, the rotating screen is horizontally aligned at a slight angle and often comprises an internal screw flight. The screw flight is operatively configured to reposition the media to be separated from the input end of the separator to the solids discharge end. As the material moves through the screen separator, liquid and fine particles are removed through the perforations in the screen.

The example hybrid rotary screen separator of the present invention comprises at least two separate regions each comprising a different screen size. In the example hybrid rotary screen separator disclosed herein, the perforations of the screen on the input end of the separator comprise a much finer hole size than the perforations toward the solid discharge end. These regions of fine screen and coarse screen may be separate structures which may be interconnected, or may alternatively be a unitary structure with separate regions of varying screen sizes along the length. In one form, these are connected to the same cylinder-like structure.

The rotary screen separator of the present invention is adapted to process a high liquid content media (effluent) or feed material comprising both a solid component and a liquid component. As the feed material enters the fine portion of the screen, a percentage of the liquid is removed. As the feed material transfers to the coarse portion of the separator, more of the liquid is allowed to escape, while much of the fine solids remain and are intertwined with the coarse solids in a concentrated slurry.

In one example rotary screen separator of the present invention, the liquid escaping from or removed while the feed material moves through the fine portion comprises less solid content than the liquid escaping from or removed while the feed material moves through the coarse portion. The liquid removed in the fine portion and the liquid removed in the coarse portion define first and second filtrate streams, respectively. The separator of the present invention may be configured such that the first and second filtrate streams exit or are removed from the separator by way of separate discharge ports should an operator wish to keep the filtrate streams separated for later processing.

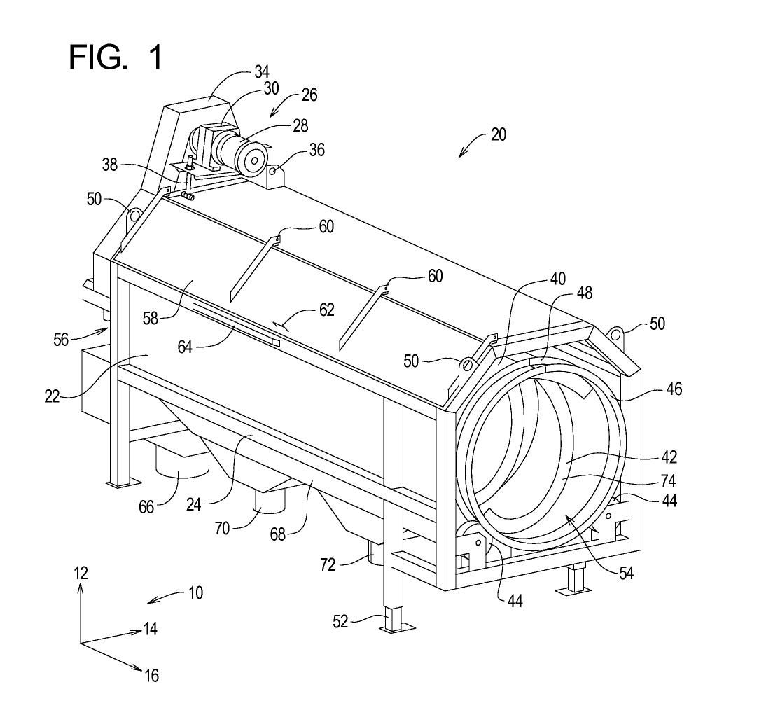

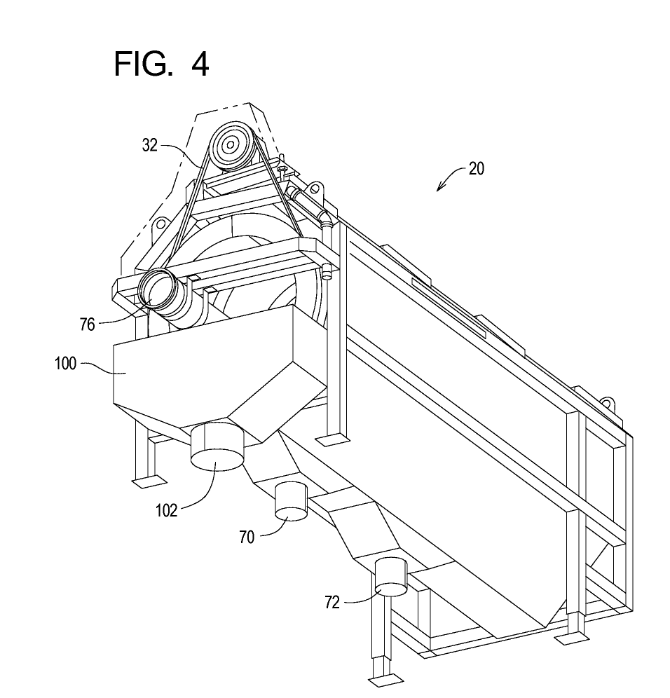

With the foregoing general understanding of the construction and operation of the present invention in mind, an example hybrid rotary screen separator constructed in accordance with, and embodying, the principles of the present invention will now be described in detail with reference to FIGS. 1-9. Initially, depicted in FIG. 1 is an axes system 10 comprising a vertical axis 12, a transverse axis 14, and a longitudinal axes 16. The axes system 10 is to be used for description of the embodiments and is not per se part of the present invention.

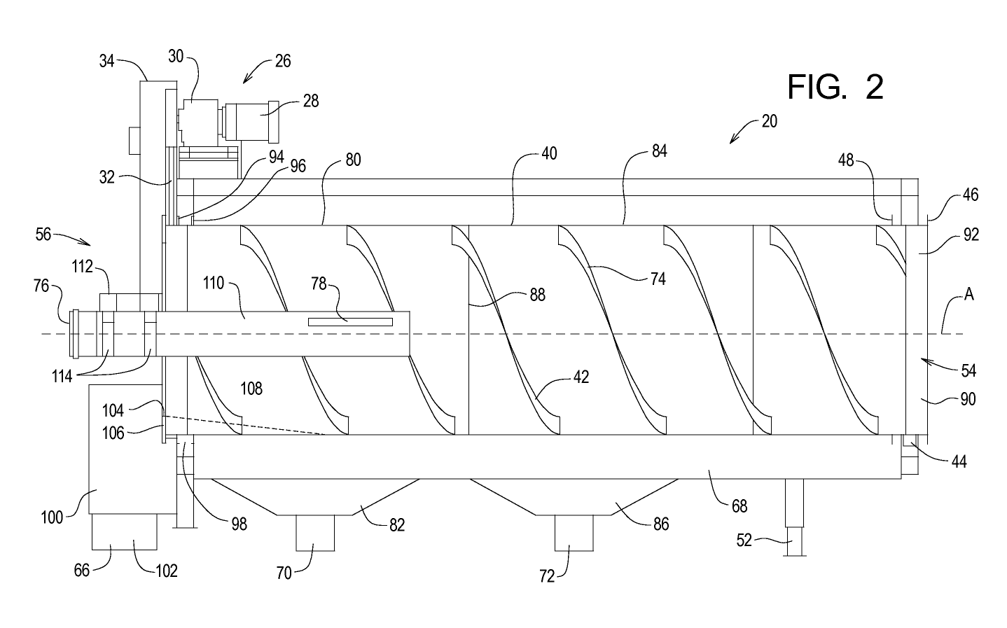

FIGS. 1 and 2 illustrate that an example hybrid rotary screen separator 20 of the present invention defines a system longitudinal axis A and generally comprises three major assemblies. The first assembly comprises a housing 22 and a frame 24. This housing and frame assembly generally supports and encloses the working portions of the separator 20.

The second assembly is the drive assembly 26 which generally comprises a drive motor 28, an optional reduction gear system 30, and a drive belt 32 which is shown in FIG. 2. In FIG. 1, the drive belt 32 is covered by a protective shroud 34. The motor 28 may be coupled to the housing 22 through a motor pivot 36 and drive tension adjuster 38.

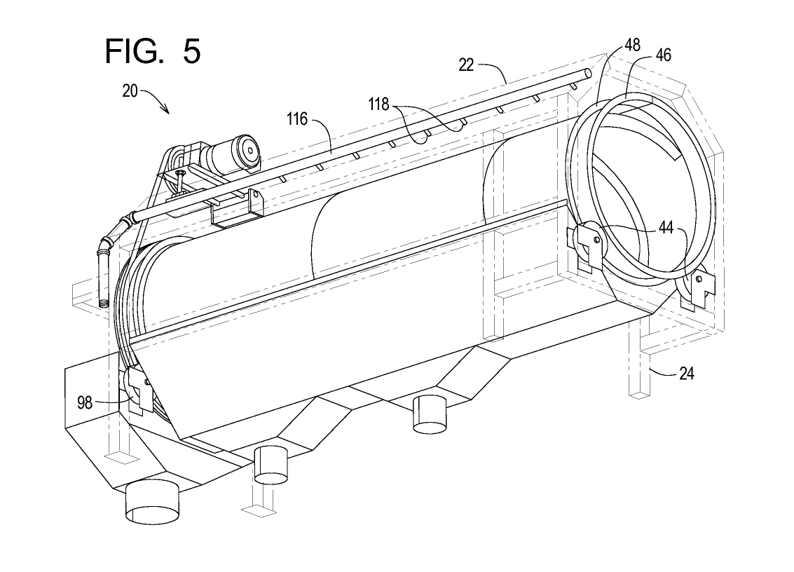

The third assembly generally comprises a rotating screen 40. As will be described in further detail below, the example rotating screen 40 includes at least two different perforation regions. The example rotating screen 40 also comprises at least one vane 42. In one form, the rotating screen 40 is substantially cylindrical. The rotating screen 40 may be driven by the drive assembly 26 and in one form rests upon a plurality of support rollers 44. The support rollers 44 may be held in place, as shown for example in FIG. 1, by an outer flange 46 and an inner flange 48. Additional components, including additional support rollers 44, will be described below with reference to FIGS. 2 and 5 at the opposite longitudinal end of the separator 20.

To increase the portability of the separator 20, a plurality of lifting eyes 50 may be provided to facilitate connection of the separator 20 to a crane or the like (not shown) for moving and transportation thereof. Furthermore, a plurality of elevation adjusters 52 may be provided to allow the end user to adjust the elevation of the solid output end 54 relative to the input end 56.

The example separator 20 further comprises an access door 58 in the housing 22. The example access door 58 pivots between open and closed positions about a plurality of access door pivots 60 to facilitate access to the interior portion of the housing 22. A handle 62 may be provided for to facilitate lifting of the access door 58. The example access door 58 is further provided with a lid holder 64. The lid holder 64 may be rotated from a storage position as shown in FIG. 1 to a bracing position in which the lid holder 64 forms a strut that supports the access door 58 in an open configuration.

Several ports are formed on the lower portion of the separator 20. One such port is a bypass outflow port 66, which will be described in further detail below. A collection pan 68 may be provided at a bottom portion of the separator 20 to receive at least a portion of the fluid output from the rotating screen 40. The example collection pan 68 defines a fine material output 70 and a coarse material output 72 corresponding to the first and second filtrate streams, respectively, generally described above. As will be described in further detail below, the fluid output of or removed from the rotating screen 40 may be diverted to one of the fine material output 70 and the coarse material output 72.

Referring now to FIG. 2, depicted therein is a cut away view of the example separator 20 taken through the drive motor 28 and along the longitudinal axis 16 and vertical axis 12. FIG. 2 further illustrates that the vanes 42 form a screw flight 74.

As generally discussed above, the example rotating screen 40 generally comprises at least two unique perforation regions. The example rotating screen 40 comprising two separate and distinct perforation regions; however, more than two unique perforation regions can also be utilized.

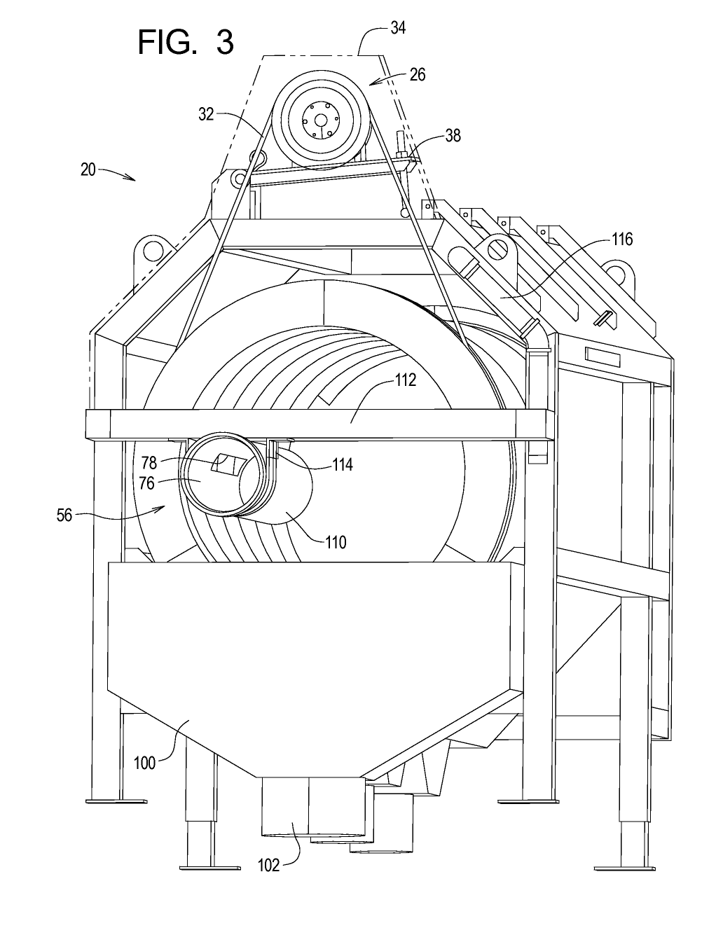

As feed material enters an example input port 76, the feed material is pressed towards a feed slot 78 (FIGS. 2 and 3). The feed material eventually exits the feed slot 78 into a fine perforation region 80 within the rotating screen 40. A portion of the liquid and some of the fine materials exit the interior of the rotating screen through the perforations in this fine perforation region 80. The material passing through the fine perforations generally redistribute toward a fine collection pan 82 and exit through the fine material output 70.

Coarser materials in the feed material that are not removed by the rotating screen 40 in the fine perforated region 80, along with fluid remaining in the feed material, are displaced away from the input port 76 by the screw flight 74 as the rotating screen 40 rotates about the longitudinal system axis A. The coarser material and liquid remaining in the feed material is thus displaced or otherwise redistributed toward the output end 54 and thus enters a coarse perforation region 84. More of the fluids and a portion of the coarser materials remaining in the feed material exit through the perforations in the coarse perforation region 84 and are collected in the collection pan 68. The coarse materials in one form reposition into the coarse collection pan 86, wherein they exit the separator 20 via the coarse material output 72.

The example rotating screen 40 is formed by two separate screens with different screen sizes, and a seam 88 is formed in the example rotating screen 40 between the fine perforation region 80 and the coarse perforation region 84. Alternatively, the cylinder formed by the rotating screen 40 may be formed from a single sheet of material and thus may be seamless.

A highly coarse portion of the feed material (i.e., has not exited through the perforations in either the fine perforation region 80 or the coarse perforation region 84) is displaced or redistributed toward the output end 54 and exits the separator 20 at a very coarse material output 90. Typically, the highly coarse portion of the feed material is collected at the coarse material output 90.

Adjacent to the example very coarse material output 90 are flanges 46 and 48 that support an additional set of rollers or idler wheels 44 that maintain position of the rotating screen 40 as generally described above. The region of the rotating screen 40 between the flanges 46 and 48 may comprise a solid region 92, which is generally not perforated. At the opposite end of the rotating screen 40, an outer flange 94 and inner flange 96 maintain position of the rotating screen 40 upon another set of idler wheels 98, which are also coupled to the frame 24.

This example separator 20 disclosed herein allows for feed material to be processed at a much faster and more efficient rate than current single screen separators of the same size. Tests have shown that a physical implementation of the example separator 20 having a rotating screen 40 of approximately 3 feet in diameter and 10 feet in length that rotates in a first range of approximately 6 to 8 rpm can separate or process feed material at a rate of around 600 gallons per minute. The rotating screen 40 constructed as defined above may be rotated at a rate within a second range of approximately 3-15 rpm.

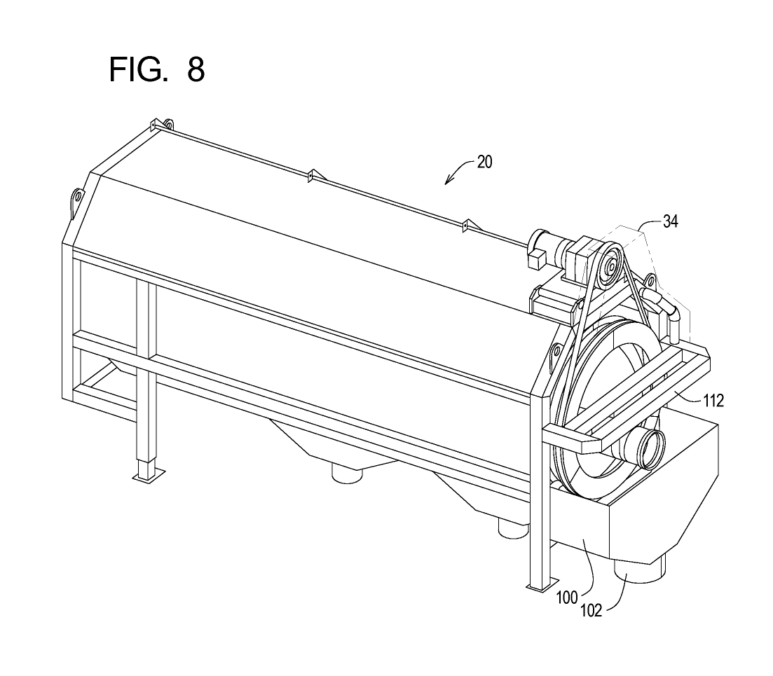

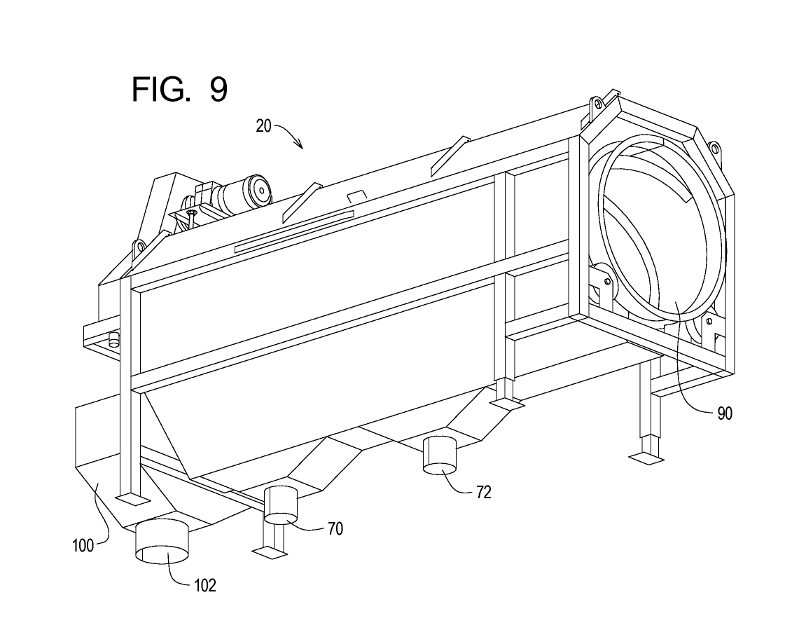

When run at a high rate, or with very dense input material, the fluid discharge to the collection pan 68 may overwhelm the capacity of the outputs 70 and 72. In this situation, a bypass collector 100 comprising a bypass outflow 102 may be employed as perhaps best shown in FIGS. 8 and 9. The bypass collector 100 defines an upper lip 104 formed by a bypass flange 106. As material within the collection pan 68 builds up towards the input end 56 of the separator 20, material within the collection pan 68 may build up beyond a maximum fill level 108 defined by the upper lip 104 of the bypass flange 106 as shown in FIG. 2.

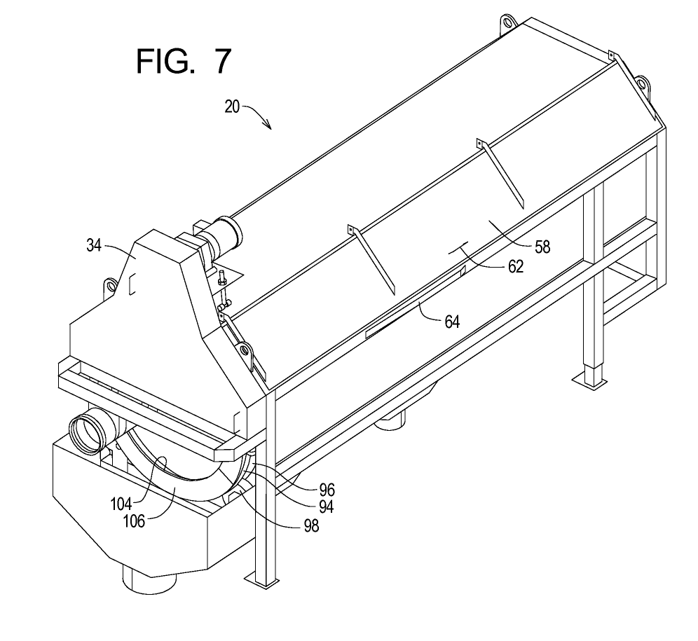

As the material within the collection pan 68 exceeds the maximum fill level 108, a liquid portion of this material flows over the upper lip 104 of the bypass flange 106 and into the bypass collector 100. This bypass collector 100 is depicted in perspective in FIG. 3, and the upper lip 104 of the bypass flange 106 is visible in FIG. 7. The outflow exiting the bypass outflow 102 may be fed by way of a gravity drain or other systems and return to the source of the media to be separated, such as a settling pond.

FIG. 3 shows the input end 56 of the example separator 20 in further detail and illustrates the shroud 34 (phantom line) and the example drive tension adjuster 38 and example drive belt 32. FIG. 3 further shows that the input port 76 is defined by an input tube 110. The example input tube 110 is coupled to a cross frame member 112 in the example separator 20. The cross frame member 112 further supports the shroud 34 and the input tube 110 by way of brackets 114 and supports the inlet tube. FIG. 3 also shows a water supply line 116 which will be described in further detail below.

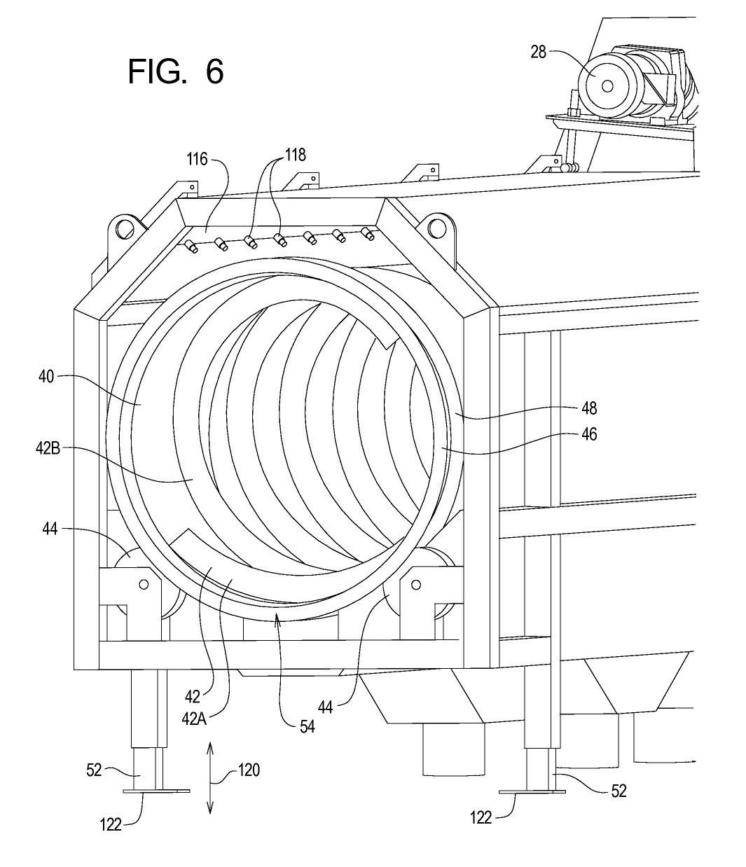

FIG. 5 shows the example separator 20 with the housing 22 and frame 24 depicted by phantom lines to allow the support rollers or idler wheels 44 and corresponding flanges 48 and 46 to be seen more clearly. FIG. 5 further shows that the example separator 20 further comprises a water supply line 116 that is coupled to a plurality of sprinklers 118. These sprinklers 118 allow the separator 20 to be operated in a self-cleaning mode in which water from the sprinklers 118 cleans the rotating screen 40. FIG. 6 also shows the water supply line 116 and sprinklers 118, but from the output end 54. FIG. 6 also illustrates that the vanes 42 may be formed by a plurality of helical vanes 42A and 42B.

FIG. 6 also shows the elevation adjusters 52. The elevation adjusters 52 of the example separator 20 allow the output end 54 to be elevated above the input end 56 with reference to a horizontal plane. The example elevation adjusters 52 thus allow a user to vary the elevation height 120 of the output end 54 above the feet 122 of the separator 20. A slight incline of the rotating screen 40 increases the efficiency of the overall apparatus. However, the separator 20 may be configured to operate anywhere between a horizontal or level orientation (0° with respect to horizontal) or may be inclined up to 5° from horizontal. Stated alternatively, in the physical embodiment of the example separator 20 as described above (a device of 10′ in overall length), the output end may raised approximately 4″ above the input end.

In one form, inclining the device from horizontal improves efficiency, while an incline of in a first range of substantially between 0° and 5° of a screen rotating at 3-15 rpm and having a diameter of about 3′ may be preferred for common effluent consistencies although other dimensions and rates will be used in other applications. In another form, the screen 40 may be inclined at an angle in a second range of substantially between 1° and 10°.

FIG. 9 illustrates that the example separator 20 defines four separate and distinct output ports for components or outflow material removed the feed material. The output ports defined by the example separator 20 comprise, from left to right, the bypass outflow 102, the fine material output 70, the course material output 72, and the very coarse or solid material output 90. It may be desired to maintain the outflow material from each outflow port separately.

As examples, the outflow material exiting the bypass outflow 102 may be channeled back to the settling pond or other source. The fine material output 70 provides a substantially liquid media which can be used unprocessed or processed as required for a particular use. The outflow material flowing out of the coarse material output 72 contains substantially more solids than the outflow material flowing through the fine material output 70. The outflow material exiting the coarse material output 72 is thus more likely to require additional processing before this material can be reused. The outflow material exiting the very coarse material output 90 should be substantially solid and comprise a very small liquid components can be used to the best advantage with or without additional processing as desired.

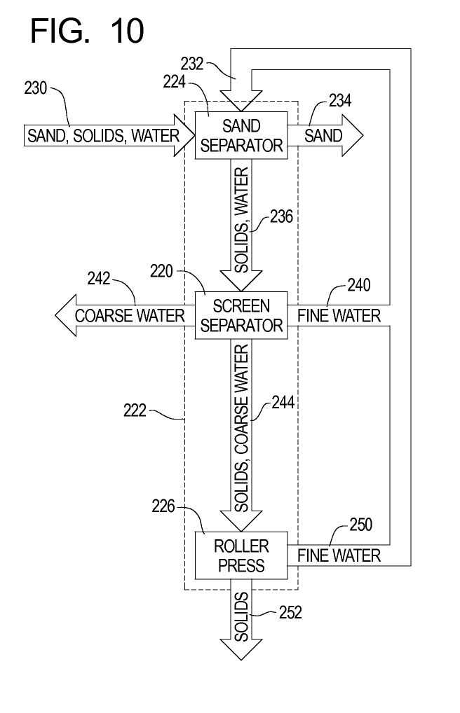

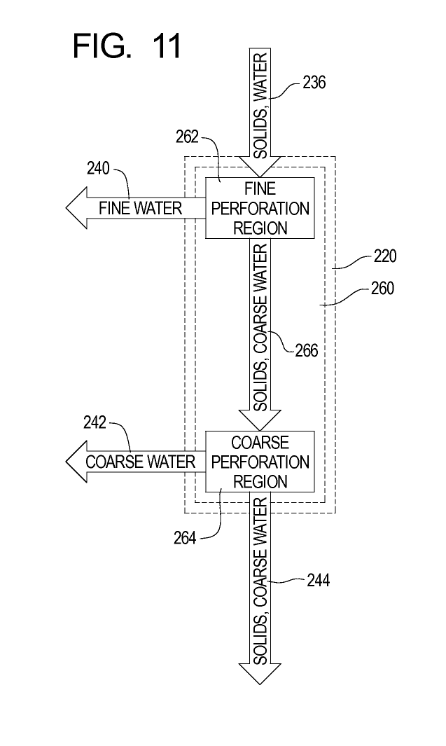

Referring now to FIG. 10 of the drawing, depicted therein is a second example hybrid rotary screen separator 220 of the present invention used as part of a first example waste processing system 222. The example hybrid rotary screen separator 220, which is depicted in further detail in FIG. 11, may be constructed to operate in a manner similar to that of the first example hybrid rotary screen separator 20 described above. The first example waste processing system 222 is described herein by way of example only, and the screen separator 220 may be used as described herein in many configurations of waste processing systems.

The principles of the present invention are of particular significance in the context of processing waste materials that are the byproduct of animal husbandry operations such as dairy farms, and that application of the present invention will now be described in further detail with reference to FIGS. 10 and 11.

Referring initially to FIG. 10 of the drawing, it can be seen that the first example waste processing system 222 comprises, in addition to the screen separator 220, a sand separator 224 and a roller press 226. The sand separator 224 may be a sand separator such as that described in copending U.S. Patent Application Ser. No. 61/434,803. The roller press 226 is or may be a conventional roller press available for use in the example waste processing system 222 as described herein.

The first example waste processing system 222 operates basically as follows. A first material 230 comprising sand, solids, and water is input to the sand separator 224. In a dairy operation, the first material 230 often contains sand because sand may be used as a bedding material for the cows. The water portion of the first material may be from rinse water, urine, or other water-based liquids used in a dairy operation. The solids are typically manure and uneaten food such as corn. Cleaning of dairy facilities creates a constant need to process the first material 230 so that its components may be reused, recycled, further processed, and/or disposed of as appropriate.

The sand separator 224 processes the first material, typically using water 232, into a second material 234 primarily comprising sand and a third material 236 primarily comprising solids and water. The second material 234 may be recycled for use as bedding material or otherwise appropriately reused or disposed of.

In the first example waste processing system 222, the third material 236 is input to the screen separator 220. The screen separator 220 processes the third material 236 to obtain a fourth material 240 commonly referred to as fine water, a fifth material 242 commonly referred to as coarse water, and a sixth material 244 primarily comprising solids and coarse water.

Fine water is a liquid that is primarily water and can be used with little or no processing in a modern dairy operation. In the first example waste processing system 222, the fourth material 240 is used as at least a portion of the water 232 used by the sand separator 224. Fine water typically has a first, relatively low, concentration of solids and/or other impurities.

Coarse water is a liquid comprises water and solids, and it is difficult to use coarse water in a modern dairy operation without additional processing. In the first example waste processing system 222, the fifth material 242 is typically stored for further processing and/or disposal as appropriate. Coarse water typically has a second, relatively high, concentration of solids and/or other impurities. The first concentration of solids associated with the fourth material 240 is thus typically significantly lower than the second concentration of solids associated with the fifth material 242.

The sixth material 244 is simply a combination of coarse water and the majority of the solids present in the third material 236 and has a third, very high, concentration of solids and/or other impurities. The second concentration of solids associated with the fifth material 242 is thus typically significantly lower than the third concentration of solids associated with the sixth material 244. It follows that the third concentration of solids is higher than the second concentration of solids and significantly higher than the first concentration of solids.

In the first example waste processing system 222, the sixth material 244 is input to the roller press 226. The roller press 226 processes the third material 236 to obtain a seventh material 250 primarily comprising fine water and an eighth material 252 primarily comprising solids, with very little liquid remaining in the eighth material 252. Like the fourth material 240, the seventh material 250 is typically appropriate for use in a dairy facility without further processing and may be used as at least a portion of the water 232 used by the sand separator 224. The eighth material 252 may be further processed by composting or in an anaerobic digester and may be reused as fertilizer and/or an energy source.

FIG. 11 is a more detailed view of the example screen separator 220 depicted in FIG. 10. As shown in FIG. 11, the example screen separator 220 comprises a separator member or screen 260 defining a fine perforation region 262 and a coarse separation region 264.

The third material 236 is first processed by the fine perforation region 262 to obtain the fourth material 240 and a transition material 266 comprising solids and coarse water. The transition material 266 is then processed by the coarse perforation region 264 to obtain the fifth material 242 and the sixth material 244. A fourth concentration of solids associated with the transition material 266 is typically significantly higher than the first concentration of solids associated with the fourth material 240 and the second concentration of solids associated with the fifth material 242. However, the fourth concentration of solids associated with the transition material is typically significantly lower than the third concentration of solids associated with the sixth material 244.

While the present invention is illustrated by description of several embodiments and while the illustrative embodiments are described in detail, it is not the intention of the applicants to restrict or in any way limit the scope of the appended claims to such detail. Additional advantages and modifications within the scope of the appended claims will readily appear to those sufficed in the art. The invention in its broader aspects is therefore not limited to the specific details, representative apparatus and methods, and illustrative examples shown and described. Accordingly, departures may be made from such details without departing from the spirit or scope of the invention.

What is claimed is:

1. A rotary screen separator for processing feed material comprising liquids and solids, the rotary screen separator comprising:
a separator member defining a longitudinal axis, an input port, an output port, a fine perforation region, and a coarse perforation region, where the fine perforation region is arranged between the input port and the output port and the coarse perforation region is arranged between the fine perforation region and the output port;
a collector structure defining a fine material output and a coarse material output;
a support structure for supporting the separator member and the collector structure;
a drive system for rotating the separator member relative to the support structure; wherein
operation of the drive system displaces feed material from the input port to the output port through the fine perforation region and the coarse perforation region;
a first portion of the feed material flows through the separator member to the fine material output in the fine perforation region, where the first portion comprises liquid and a first concentration of solids;
a second portion of the feed material flows through the separator member to the coarse material output in the coarse perforation region, where
the second portion comprises liquid and a second concentration of solids, and
the second concentration of solids is higher than the first concentration of solids; and
a third portion of the feed material flows through the output port, where
the third portion comprises liquid and a third concentration of solids, and
the third concentration of solids is higher than the second concentration of solids.

2. A rotary screen separator as recited in claim 1, in which the support structure supports the separator member at an angle with respect to horizontal.

3. A rotary screen separator as recited in claim 1, in which the support structure supports the separator member at an angle of substantially between zero and five degrees with respect to horizontal.

4. A rotary screen separator as recited in claim 1, in which the support structure supports the separator member at an angle of substantially between one and ten degrees with respect to horizontal.

5. A rotary screen separator as recited in claim 1, further comprising at least one vane operatively connected to the separator member, where operation of the drive system to rotate the separator causes the at least one vane to displace the feed material from the input opening to the output opening.

6. A rotary screen separator as recited in claim 5, in which the at least one vane is helical.

7. A rotary screen separator as recited in claim 6, in which the at least one vane extends from an inner surface of the separator member.

8. A rotary screen separator as recited in claim 1, in which the separator member is perforated, where perforations in the fine perforation region are smaller than perforations in the coarse perforation region.

9. A rotary screen separator as recited in claim 1, in which the separator member comprises first and second perforated members associated with the fine and coarse perforation regions, respectively, and perforations in the first perforation member are smaller than perforations in the second perforation member.

10. A rotary screen separator as recited in claim 1, further comprising a bypass collector arranged to collect fluids within the fine perforation region.

11. A rotary screen separator as recited in claim 1, in which the output structure substantially prevents flow between the fine material output and the coarse material output.

12. A method of processing feed material to separate the feed material into separate portions comprising the steps of:
providing a separator member defining a longitudinal axis, an input port, an output port, a fine perforation region, and a coarse perforation region, where the fine perforation region is arranged between the input port and the output port and the coarse perforation region is arranged between the fine perforation region and the output port;
providing a collector structure defining a fine material output and a coarse material output;
supporting the collector structure relative to the separator member;
rotating the separator member relative to the support structure such that the feed material is displaced from the input port to the output port through the fine perforation region and the coarse perforation region;
collecting at the fine material output a first portion of the feed material that flows through the separator member in the fine perforation region, where the first portion comprises liquid and a first concentration of solids;
collecting at the coarse material output a second portion of the feed material that flows through the separator member in the coarse perforation region; where
the second portion comprises liquid and a second concentration of solids, and
the second concentration of solids is higher than the first concentration of solids; and
allowing a third portion of the feed material to flow through the output port, where
the third portion comprises liquid and a third concentration of solids, and
the third concentration of solids is higher than the second concentration of solids.

13. A method as recited in claim 12, in which the step of supporting the separator member comprises the step of arranging the separator member at an angle with respect to horizontal.

14. A method as recited in claim 12, in which the step of supporting the separator member comprises the step of supporting the separator member at an angle of substantially between zero and five degrees with respect to horizontal.

14. A method as recited in claim 12, in which the step of supporting the separator member comprises the step of supporting the separator member at an angle of substantially between one and ten degrees with respect to horizontal.

15. A method as recited in claim 12, further comprising the step of operatively connecting at least one vane to the separator member such that operation of the drive system to rotate the separator causes the at least one vane to displace the feed material from the input opening to the output opening.

16. A method as recited in claim 12, further comprising the steps of forming perforations in the separator member, where the perforations formed in the fine perforation region that are smaller than perforations formed in the coarse perforation region.

17. A method as recited in claim 12, further comprising the step of arranging a bypass collector to collect fluids within the fine perforation region.

18. A method as recited in claim 12, further comprising the step of a substantially preventing flow of fluid between the fine material output and the coarse material output.

19. A rotary screen separator for processing feed material comprising:
a perforated separator member defining a longitudinal axis, an input port, an output port, a fine perforation region, and a coarse perforation region, where
the fine perforation region is arranged between the input port and the output port and the coarse perforation region is arranged between the fine perforation region and the output port, and
perforations in the first perforation member are smaller than perforations in the second perforation member;
at least one vane operatively connected to the separator member;
a collector structure defining a fine material output and a coarse material output;
a support structure for supporting the separator member and the collector structure at an angle with respect to horizontal;
a drive system for rotating the separator member relative to the support structure; wherein
operation of the drive system causes the at least one vane to displace feed material from the input port to the output port through the fine perforation region and the coarse perforation region;
a first portion of the feed material flows through the separator member to the fine material output in the fine perforation region, where the first portion comprises liquid and a first concentration of solids;
a second portion of the feed material flows through the separator member to the coarse material output in the coarse perforation region, where
the second portion comprises liquid and a second concentration of solids, and
the second concentration of solids is higher than the first concentration of solids; and
a third portion of the feed material flows through the output port, where the third portion comprises liquid and a third concentration of solids, and
the third concentration of solids is higher than the second concentration of solids.

20. A rotary screen separator as recited in claim 19, in which the support structure supports the separator member at an angle of substantially between zero and five degrees with respect to horizontal.

21. A rotary screen separator as recited in claim 19, in which the support structure supports the separator member at an angle of substantially between one and ten degrees with respect to horizontal.

22. A rotary screen separator as recited in claim 19, further comprising a bypass collector arranged to collect fluids within the fine perforation region.

23. A rotary screen separator as recited in claim 10, in which the output structure substantially prevents flow between the fine material output and the coarse material output.
